(19) United States
(12) Patent Application Publication
(10) Pub. No.: US 2010/0264233 A1
(43) Pub. Date: Oct. 21, 2010

(54) DEVICE AND METHOD FOR PRODUCING PARTICLES

(75) Inventor: Kai Asikkala, Helsinki (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/745,866

(22) PCT Filed: Dec. 19, 2008
(86) PCT No.: PCT/FI2008/050778

§ 371 Date: Jun. 2, 2010

(30) Foreign Application Priority Data
Dec. 20, 2007 (FI) 20071001

(51) Int. Cl. B05B 1/02

(52) U.S. Cl. 239/8; 239/418

(57) ABSTRACT

A method and a device for producing particles in which a liquid is atomized into droplet sprays via at least two atomizers. At least two atomizers are arranged directed towards one another such that the droplet sprays produced thereby collide with one another so as to form mist, and that the device also includes a thermal reactor, where the mist forms particles having an average aerodynamic diameter of less than 1000 nm.

### BACKGROUND OF THE INVENTION

The present invention relates to a device for producing particles, and in particular, to a device in accordance with the preamble of claim 1 for forming particles, the device comprising at least two atomizers that atomize one or more liquids into droplet sprays. The present invention also relates to a method for producing particles, and in particular to a method in accordance with the preamble of claim 15 for forming particles, in which method at least one liquid is atomized into two or more droplet sprays.

A liquid may be atomized into tiny droplets with a variety of techniques, such as a gas-dispersed atomizer, a pressure-dispersed atomizer and an ultrasound atomizer. Various atomization manners have been described comprehensively in the publication by Huimin Liu, “Science and Engineering of Droplets—Fundamentals and Applications, (2000), William Andrew Publishing, LLC, New York, p. 19-120, particularly p. 59-61, describing a so-called “whistle atomization” device, in which colliding liquid jets are atomized by means of ultrasound. By means of the device it is possible to produce from water droplets of less than 10 micrometres at a high production rate.

Patent publication FI98832, dated 16 Mar. 1997 (Liekki Oy), describes a method and a device for spraying material, whereby the substance to be sprayed is led to a flame produced by means of a combustion gas and the particles in the material to be sprayed are sprayed by means of the flame to a desired target. The substance to be sprayed is passed to the flame in liquid form and atomized by means of a gas substantially in the vicinity of the flame. Thus, it is possible to produce extremely tiny particles, in the order of nanometres, rapidly, economically and in a single phase. The device of the publication has a problem that nanoparticles are created in a high-rate flame and in the device the atomization process and the flame formation process are interlinked, and the device does not comprise a degree of freedom for optimizing the atomization and the flame independently of one another. The device does not allow simultaneous production of particles from liquids of different types either.

The prior art thus poses a problem that production of mist or aerosol of good quality at a high production rate requires a complicated device. Further, when mist or aerosol is used for producing nanomaterial, a problem with the prior art is to separate different process steps, such as atomization and flame formation, from one another.

### BRIEF DESCRIPTION OF THE INVENTION

The object of the present invention is thus to provide a method and a device implementing the method such that the above problems can be eliminated. This is achieved by a device in accordance with the characterizing part of claim 1, which is characterized in that at least two atomizers that are arranged directed towards one another such that droplet sprays produced thereby collide with one another to form a mist or an aerosol, and that the device also comprises a thermal reactor, where the mist or the aerosol forms particles whose average aerodynamic diameter is less than 1000 nm. The object of the invention is further achieved by a method in accordance with the characterizing part of claim 15, which is characterized by guiding at least two droplet sprays towards one another such that the droplet sprays collide with one another to form a mist or an aerosol and conveying the formed mist or aerosol into the thermal reactor, where the mist or the aerosol forms particles whose average aerodynamic diameter is less than 1000 nm.

Preferred embodiments of the invention are disclosed in the dependent claims.

The device and the method in accordance with the present invention are based on a surprising observation that as two atomized droplet sprays are directed to collide with one another there is produced an aerosol or a mist whose droplets are tiny. An aerosol refers to a mixture in which solid or liquid particles float in a gas. In this context, a mist refers to a mixture which includes solid or liquid particles whose average size is larger than in the aerosol. Advantageously, when droplet sprays are directed substantially straight against one other there is obtained a mist or an aerosol whose mobility is nearly nonexistent, whereby said mist or aerosol may be moved in a desired direction with a separate gas flow directed substantially to the collision point of the droplet sprays. Because the droplet sprays do not coalesce until at the collision point, said device allows production of a mist or aerosol that consists of at least two different liquids, such as droplets atomized from water and methanol, which liquids may be mutually immiscible, such as water and benzine, or mutually reactive in such a manner that they cannot be led together in the same atomizer, for instance, because the liquids would together form a gelling mixture, such as water containing a metallic salt and tetramethylorthosilane (TEOS). With the device of the invention it is possible to produce mist and aerosol also from mixtures, liquids that contain a solvent and a metallic salt dissolved therein, or liquids that are colloidal solutions. The average droplet size of droplets produced by different atomizers need not necessarily be the same, whereby the average droplet size in droplets sprays colliding with one another differs. From the viewpoint of operational performance of the device it is advantageous if the momentum of the colliding droplet sprays is substantially the same, whereby, on the basis of the law of momentum conservation, the momentum of the produced mist is substantially zero. In other words, the momentums are substantially the same, but of the opposite signs. Hence, the device and the method of the invention permit formation of mists consisting of various materials. From the obtained mist or aerosol the device and the method of the invention further produce nanosize particles of solid material having a diameter of 1 to 1000 nm.

Thus, with the device and the method of the invention it is possible to provide particles, such as metallic or metallic oxide particles, whose average aerodynamic diameter is less than 1000 nm. These particles are advantageously produced such that the mist or aerosol produced with the device of the invention and containing at least one metallic salt is led into a thermal reactor, where the mist droplets or the aerosol droplets and the metal contained therein evaporate, and nanosize metallic or metallic oxide particles are created through nucleation and condensation. Advantageously said thermal reactor is a flame produced by means of gas burning. In that case, it is advantageous to use at least one exothermal liquid in the device of the invention. Further, it is advantageous to use for atomization of the liquids at least one of the gases required for flame formation, such as hydrogen, oxygen or hydrogen/oxygen mixture. Into the device of the invention it is also possible to feed at least one gas that reacts in thermal reactor and forms metallic or metallic oxide particles.

The present invention has an advantage that the device of the invention allows production of mist or aerosol of uniform quality, wherefrom nanoparticles of uniform quality will be further produced for use in coating processes, for instance. Because the device of the invention may have various embodiments, the mist or the aerosol may be shaped into a line-like mist front or aerosol front, whereby the mist or the aerosol may create a line-like nanoparticle jet, which may be advantageously used for coating a broad, ribbon-like material, for instance. Examples of these include a paper web on a paper machine, textile sheet on a textile machine or a glass ribbon of a glass-making process, in particular of a float process.

### BRIEF DESCRIPTION OF THE DRAWINGS

In the following the invention will be described in greater detail, in connection with preferred embodiments, with reference to the attached drawings, in which

FIG. 1 is a schematic view of the principle of the device in accordance with the invention, in which two gas-dispersed atomizers are directed substantially against one another;

FIG. 2 shows an embodiment of the device in accordance with the invention, in which a flame generated by a gas flow serves as a thermal reactor; and

FIG. 3 shows another embodiment of the device in accordance with the invention, in which a flame generated by burning an exothermal liquid serves as the thermal reactor.

### DETAILED DESCRIPTION OF THE INVENTION

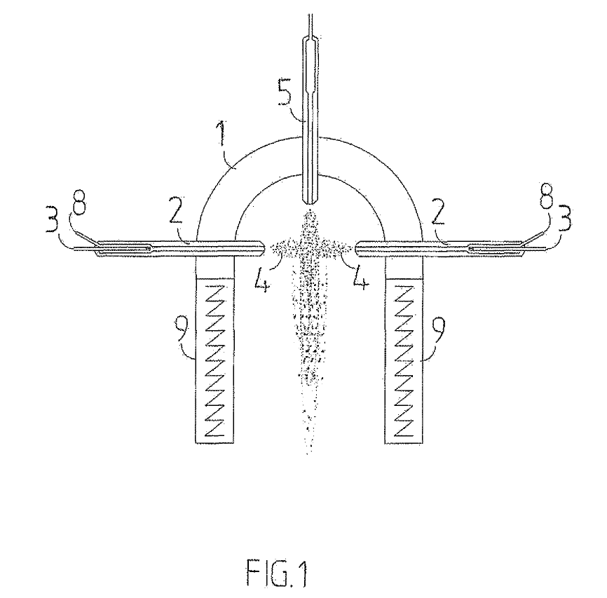

FIG. 1 shows a device of the invention for producing particles. In the body 1 of the device there are secured two atomizers 2 directed substantially towards one another. The atomizers 2 are arranged in the device directed straight towards one another in accordance with FIG. 1. In other words, advantageously the atomizers 2 are arranged directed substantially coaxially towards one another such that their droplet sprays 4 collide substantially straight against one another. The device may comprise two or more atomizers 2. Advantageously, the atomizers 2 are arranged in pairs so as to form one or more atomizer pairs such that the atomizers 2 of each atomizer pair are directed substantially straight, advantageously coaxially, towards one another, whereby the droplet sprays 4 of each atomizer pair collide straight with one another. In the device the atomizer pairs may further be arranged in succession or side by side vertically or horizontally.

A liquid 3 to be atomized and an atomizing gas 8 are fed into the atomizer 2. The atomizing gas 8 and the liquid 3 are fed into the atomizer 2 advantageously at different rates, whereby the rate difference between the atomizing gas 8 and the liquid 3 at the output of the atomizer 2 provides atomization of the liquid 3 into a droplet spray 4 that consists of tiny droplets. The droplet sprays 4 collide with one another, whereby there is surprisingly produced mist or aerosol consisting of tiny droplets. The droplet spray 4 in itself may constitute the mist or the aerosol. When the droplet sprays that are directed substantially straight towards one another collide straight against one another there will be provided a mist or an aerosol whose mobility is nearly nonexistent, their momentums being substantially the same. Further, the device may be arranged to include means for feeding at least two different liquids 3 to at least two different atomizers. In other words, the device may be provided such that it is possible to feed the same or different liquids 3 to two or more atomizers 2. In other words, if so desired, it is possible to feed the same or different liquids to the atomizers 2 of each atomizer pair. In addition, at least two atomizer pairs may use the same liquid or liquids as the other atomizer pairs. In that case each atomizer pair may produce, if so desired, the mist that is different from or the same as that produced by the adjacent atomizer pair. Further, the atomizers 2 of the device may be arranged to produce droplet sprays 4 whose droplets are substantially different or the same in average droplet size. The droplet size may be affected, for instance, by the geometry of the atomizers 2 or by the atomizing gas rate or the rate difference between them. This enables production of mist or aerosol that is homogeneous or heterogeneous in droplet size.

Advantageously, the device also comprises means for conveying a gas flow of a gas from at least one direction to the collision point of the droplet sprays 4. This is advantageously implemented by providing the device with a gas nozzle 5 for feeding the gas from at least one direction to the collision point of the droplet sprays 4. Thus, it is possible to move or displace the mist or aerosol produced at the collision point of the droplet sprays 4 to a desired direction by means of the gas flow. It is possible to use any gas in the gas nozzle 5. In other words, it may be an inert gas, or alternatively, it may be a combustion gas or gas that reacts with the mist or aerosol. In the embodiment of FIG. 1, the gas nozzle 5 is arranged in the device such that the gas flow runs and collides substantially perpendicularly to the droplet sprays 4.

In the embodiment of FIG. 1 the device also comprises a thermal reactor that is provided by heaters 9, such as electric resistances. The thermal reactor may also be provided by a flame, microwaves or laser radiation, for instance. The gas flow discharged from the gas nozzle 5 thus guides the generated mist or aerosol into the thermal reactor. In the thermal reactor 9 at least some of material contained in the mist or aerosol evaporates, whereby the droplets in the mist or the aerosol may form nanoparticles whose average aerodynamic diameter is less than 1000 nm. In that case, for instance, in the thermal reactor the solvent present in the mist or aerosol evaporates, as well as the metal contained in the mist or the aerosol. As the metal cools down, it forms either metallic or metallic oxide particles through nucleation and condensation. In accordance with FIG. 1, the thermal reactor is provided by one or more heaters 9, which may be electric resistances or the like.

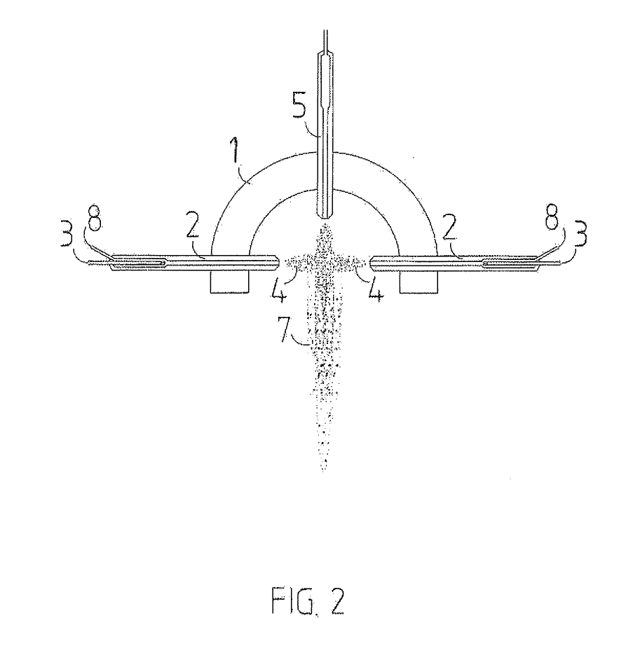

FIG. 2 shows another embodiment of the device in accordance with the invention for producing mist or aerosol and further for producing nanoparticles from the mist or the aerosol. In the body 1 of the device there are mounted two atomizers 2 directed substantially towards one another. Into the atomizer 2 there is fed liquid 3 to be atomized and atomizing gas 8. The rate difference between the atomizing gas 8 and the liquid 3 at the output of the atomizer 2 provides atomization of the liquid 3 into droplet sprays comprising tiny droplets 4. The droplet sprays 4 collide with one another, whereby there is surprisingly generated mist or aerosol consisting of extremely tiny droplets. From the gas nozzle 5 secured to the body 1 of the device there is fed gas substantially to the collision point of the droplet sprays 4. The gas flow discharging from the gas nozzle 5 consists of a combustion gas, such as hydrogen, and an oxidizing gas, such as oxygen. The rate of the gas flow at the output end of the gas nozzle is substantially higher than the propagation rate of the flame front in the gas mixture, whereby the flame does not burn inside the gas nozzle 5. The gas mixture discharging from the gas nozzle is ignited, whereby a flame 7 is formed, which serves as the thermal reactor. The gas mixture producing the flame 7 guides the created mist or aerosol into the flame 7. In an embodiment the droplets in the droplet spray 4 produced in at least second atomizer contain a metallic salt dissolved in a solvent. The solvent in the mist or the aerosol evaporates in the flame 7, as well as the metal contained in the mist or the aerosol. When the metal cools down it forms either metallic or metallic oxide particles through nucleation and condensation. In accordance with the above, this embodiment combines the kinetic effect of the gas flow on the mist and aerosol and the flame 7 formation for producing particles from the mist or the aerosol.

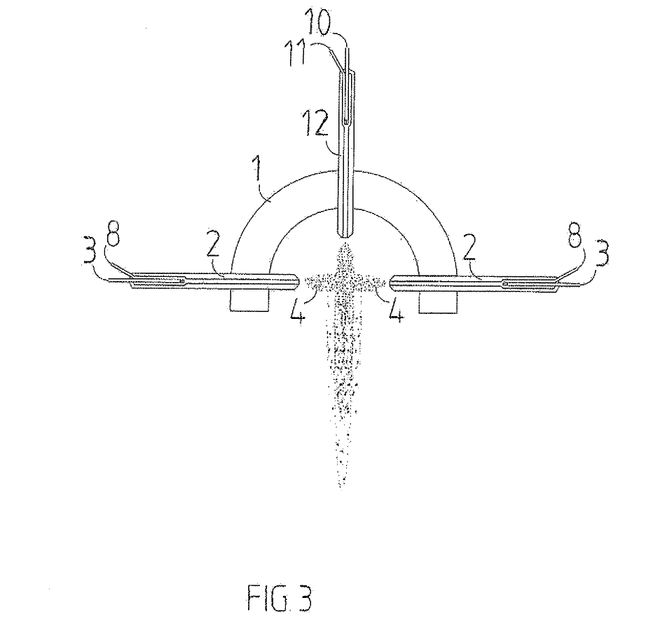

FIG. 3 shows another embodiment of the device in accordance with the invention for producing mist or aerosol and further for producing nanoparticles from the mist or the aerosol. In the body 1 of the device there are mounted two atomizers 2 directed substantially towards one another. Into the atomizer 2 there is fed liquid 3 to be atomized and atomizing gas 8. The rate difference between the atomizing gas 8 and the liquid 3 at the output of the atomizer 2 provides atomization of the liquid 3 into droplet sprays comprising tiny droplets 4. The droplet sprays 4 collide with one another, whereby there is surprisingly generated mist or aerosol consisting of extremely tiny droplets. Exothermal liquid droplets 10 and an oxidizing gas 11 (together an aerosol) are fed from the atomizer 12 secured to the body 1 of the device substantially to the collision point of the droplet sprays 4. The aerosol discharging from the atomizer 12 is ignited, whereby a flame 7 is formed, which serves as the thermal reactor. In that case the oxidizing gas 11 serves as an atomizing gas for the exothermal liquid 10. The aerosol producing the flame 7 guides the produced mist or aerosol into the flame 7. In an embodiment the droplets in the droplet spray 4 produced in at least second atomizer 2 contain metallic salt dissolved in a solvent. The solvent in the mist or the aerosol evaporates in the flame 7, as well as the metal contained in the mist or the aerosol. When the metal cools down, it forms either metallic or metallic oxide particles through nucleation and condensation.

The embodiments of previous FIGS. 1, 2 and 3 may be combined in a desired manner. In addition, the atomizers 2 may be mounted or provided such that the droplet sprays 4 produced thereby collide with one another at a desired angle. In an advantageous case the droplet sprays 4 collide substantially straight with one another, whereby the collision angle between them is about 180 degrees. When the droplet sprays collide substantially straight with one another, the atomizers 2 may be mounted such that they are facing one another substantially coaxially.

In the method of the present invention for producing a mist or an aerosol, one or more liquids are atomized into two or more droplet sprays 4. In accordance with the invention at least two droplet sprays 4 are directed substantially straight towards one another such that the droplet sprays 4 collide straight with one another. Advantageously, two droplet sprays 4 are directed substantially coaxially towards one another such that the droplet sprays 4 collide substantially straight against one another. In this context, coaxiality refers to the droplet sprays moving substantially coaxially towards one another. In the method it is possible to direct two or more droplet sprays 4 in pairs straight towards one another for forming one or more droplet spray pairs such that the droplet sprays 4 directed straight towards one another collide straight with one another. The droplet sprays 4 directed substantially straight against one another are atomized such that the droplets therein are substantially different or the same in average droplet size.

In the method it is possible to provide at least two different droplet sprays 4 using at least two different liquids 3. Thus, the colliding droplet sprays 4 may be produced from the same or different liquids 3. Likewise, different droplet spray pairs may use different liquids 3 or the same liquid(s) 3. The different liquids 3 used may be mutually immiscible or miscible. In an embodiment of the invention there is used at least one liquid 3 that contains a solvent and a metallic salt dissolved therein. The solvent may be an exothermal liquid. In addition, the liquid used in the method may be a mixture, an emulsion or a colloidal solution.

The mist or the aerosol produced in the collision of the droplet sprays 4 is substantially immobile, when the momentums of the droplet sprays 4 are substantially equal. Thus, the produced mist may be moved by conveying at least one gas flow to the collision point of the droplet sprays 4. By means of the gas flow it is possible to move the mist or the aerosol, and moreover, it is possible to control its shape. In an embodiment the gas flow is conveyed to the collision point of the droplet sprays 4 substantially perpendicularly to the droplet sprays 4. Alternatively, it is also possible to convey two or more gas flows to the collision point of the droplet sprays 4.

Advantageously, the obtained mist or aerosol is further guided by means of the above-mentioned gas flow, for instance, to a thermal reactor, where at least some of the material contained in the mist or the aerosol evaporates, whereby the droplets in the mist or the aerosol may form nanoparticles whose average aerodynamic diameter is less than 1000 nm.

The thermal reactor used may be a flame or a space that is heated by an external heat source. Gases required for producing the flame 7 may be fed along with at least one droplet spray 4 coming from an atomizer 2. Alternatively or additionally, gases required for producing the flame 7 are fed along with at least one gas flow from a gas nozzle 12 guiding the droplet sprays 4. Further, gases required for producing the flame 7 may be fed with an atomizer 12, from which there are also fed droplets produced from an exothermal liquid 10. In that case the gas 11 required for producing the flame 7, such as an oxidizing gas, may serve as an atomizing gas that atomizes the exothermal liquid 10 into droplets. When the droplets in the droplet spray 4 produced by at least one of the atomizers 2 contain a metallic salt dissolved in a solvent, the solvent present in the mist or the aerosol vaporizes in the flame 7, and so does the metal contained in the mist. The vaporized metal forms either metallic or metallic oxide particles through nucleation and condensation (gas-to-particle conversion).

It is apparent to a person skilled in the art that as technology advances, the inventive whole may be implemented in a variety of ways. The invention and the embodiments thereof are not restricted to the above examples, but they may vary within the scope of the claims.

1-29. (canceled)

30. A device for producing particles, the device comprising at least two atomizers that atomize a liquid conveyed therein into droplet sprays, wherein the at least two atomizers are arranged directed towards one another such that the droplet sprays produced thereby collide with one another so as to form a mist or an aerosol and that the device also comprises a thermal reactor, where particles having an average aerodynamic diameter of less than 1000 nm are formed from the mist or the aerosol.

31. The device of claim 30, wherein at least two atomizers are arranged directed towards one another substantially coaxially such that the droplet sprays thereof collide substantially straight against one another.

32. The device of claim 30, wherein the atomizers are arranged in pairs to form one or more atomizer pairs such that the atomizers of each atomizer pair are directed substantially straight towards one another.

33. The device of claim 30, wherein the device comprises means for conveying a gas flow from at least one direction to the collision point of the droplet sprays.

34. The device of claim 33, wherein the device comprises at least one gas nozzle for feeding gas from at least one direction to the collision point of the droplet sprays.

35. The device of claim 34, wherein the gas nozzle is arranged in the device such that the gas flow runs substantially perpendicularly to the droplet sprays.

36. The device of claim 30, wherein the device includes means for feeding at least two different liquids to at least two different atomizers.

37. The device of claim 30, wherein at least two atomizers are arranged to produce droplet sprays whose droplets are substantially different in average droplet size.

38. The device of claim 30, wherein the thermal reactor is a flame or a space that is heated with separate heaters.

39. A method for producing particles, in which method at least one liquid is atomized into two or more droplet sprays, wherein the method comprises directing at least two droplet sprays towards one another such that the droplet sprays collide with one another so as to form a mist or an aerosol, and conveying the formed mist or aerosol into a thermal reactor, where particles having an average aerodynamic diameter of less than 1000 nm are formed from the mist or the aerosol.

40. The method of claim 39, wherein the method comprises directing two droplet sprays substantially straight towards one another such that the droplet sprays collide substantially straight against one another.

41. The method of claim 39, wherein the method comprises directing the droplet sprays in pairs towards one another for forming one or more droplet spray pairs such that the droplet sprays directed towards one another collide straight with one another.

42. The method of claim 39, wherein the method comprises conveying a gas flow from at least one direction to the collision point of the droplet sprays.

43. The method of claim 42, wherein the gas flow is conveyed to the collision point of the droplet sprays substantially perpendicularly to the droplet sprays.

44. The method of claim 39, wherein at least one gas flow contains at least one gas that reacts in the thermal reactor.

45. The method of claim 39, wherein the method comprises using a flame as the thermal reactor or forming the thermal reactor of a space that is heated with separate heaters.

46. The method of claim 39, wherein the method comprises providing at least two different droplet sprays using at least two different liquids.

47. The method of claim 39, wherein the method comprises atomizing the droplet sprays directed substantially against one another such that their droplets are substantially different in average droplet size.
